(19) United States
(12) Patent Application Publication
(10) Pub. No.: US 2011/0259220 A1
(43) Pub. Date: Oct. 27, 2011

(54) GRAVURE PRINTING PRESS

(76) Inventors: Ohra Sakata, Ibaraki (JP); Shigenori Iwabuchi, Ibaraki (JP); Takakazu Mimura, Ibaraki (JP); Daisuke Yamaguchi, Ibaraki (JP)

(21) Appl. No.: 13/094,739

(22) Filed: Apr. 26, 2011

(30) Foreign Application Priority Data
Apr. 27, 2010 (JP) 102110/2010

(51) Int. Cl. B41F 9/10

(52) U.S. Cl. 101/157

(57) ABSTRACT

A gravure printing press includes a gravure plate cylinder which includes, on its circumferential surface, a plurality of recesses that form image areas upon being filled with ink, an ink supply device which supplies the ink onto the circumferential surface of the gravure plate cylinder, a first blade which comes into contact with the circumferential surface of the gravure plate cylinder at a contact angle of less than 45°, and a second blade which comes into contact with the circumferential surface of the gravure plate cylinder at a contact angle of more than 45°.

### BACKGROUND OF THE INVENTION

The present invention relates to a doctor blade of a gravure printing press.

As disclosed in Japanese Patent Laid-Open No. 07-24990, a conventional gravure printing press includes a gravure plate cylinder which includes, on its circumferential surface, a large number of minute recesses that form image areas upon being filled with ink, an ink supply device which supplies the ink onto the circumferential surface of the gravure plate cylinder, a doctor blade, the distal end of which comes into contact with the circumferential surface of the gravure plate cylinder to scrape away the ink adhering on portions other than the recesses in the gravure plate cylinder, and an impression cylinder which is opposed to and in contact with the gravure plate cylinder. In this arrangement, the ink in the recesses of the gravure plate cylinder is transferred and printed on a printing object, which is supplied between the gravure plate cylinder and the impression cylinder.

The doctor blade of the gravure printing press has not only a function of scraping away the ink adhering on portions other than the large number of minute recesses that form image areas in the gravure plate cylinder, but also a function of filling the large number of recesses with the ink supplied from the ink supply device. Therefore, when only one doctor blade is provided, as in the case of the above-mentioned gravure printing press, not only a necessary amount of ink cannot fill the recesses, but also an ink scraping failure occurs in the non-image areas. In this case, a printing failure occurs. Especially when wiring lines are formed on a sheet substrate using ink which contains, e.g., silver paste and therefore has high viscosity, the occurrence of a printing failure becomes conspicuous, thus leading to a conduction failure of the wiring lines.

### SUMMARY OF THE INVENTION

It is an object of the present invention to provide a gravure printing press which attains a higher printing quality.

In order to achieve the above-mentioned object, according to the present invention, there is provided a gravure printing press comprising a gravure plate cylinder which includes, on a circumferential surface thereof, a plurality of recesses that form image areas upon being filled with ink, an ink supply device which supplies the ink onto the circumferential surface of the gravure plate cylinder, a first blade which comes into contact with the circumferential surface of the gravure plate cylinder at a contact angle of less than 45°, and a second blade which comes into contact with the circumferential surface of the gravure plate cylinder at a contact angle of more than 45°.

### BRIEF DESCRIPTION OF THE DRAWINGS

FIG. 1 is a view showing an array of cylinders in the main part of a gravure printing press according to the first embodiment of the present invention;

FIG. 2A is a side view showing a first doctor blade having a contact angle θ1 with the circumferential surface of a gravure plate cylinder, that is less than 45°;

FIG. 2B is a side view showing a second doctor blade having a contact angle θ2 with the circumferential surface of the gravure plate cylinder, that is more than 45°;

FIG. 3 is a view showing an array of cylinders in the main part of a gravure printing press according to the second embodiment of the present invention;

FIGS. 4A to 4D are views for explaining an ink transfer operation by a blanket cylinder shown in FIG. 3;

FIG. 5 is a side view showing a gravure plate cylinder according to the third embodiment of the present invention; and

FIG. 6 is a view for explaining an ink scraping operation by a doctor blade shown in FIG. 5.

### DESCRIPTION OF THE PREFERRED EMBODIMENTS

### First Embodiment

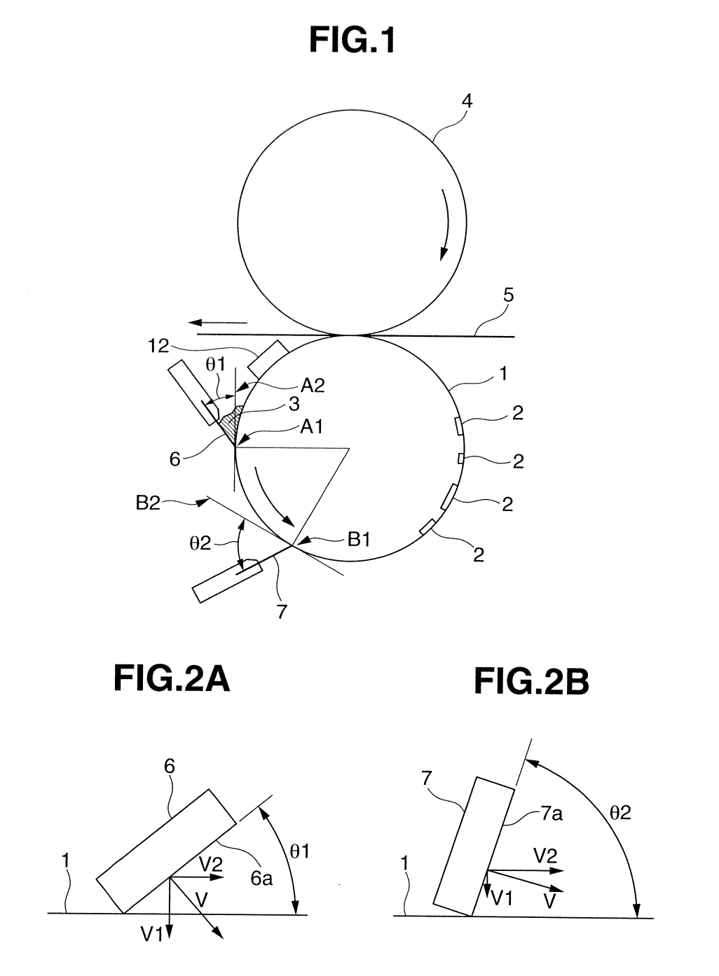

The first embodiment of the present invention will be described first with reference to FIGS. 1, 2A, and 2B. As shown in FIG. 1, an impression cylinder 4 is opposed to a gravure plate cylinder 1 while their circumferential surfaces are kept in contact with each other. The gravure plate cylinder 1 includes, on its circumferential surface, a large number of recesses 2 that form image areas upon being filled with ink. Ink 3 containing sliver paste (conductive paste) for an electrode is supplied from a chamber type ink supply device 12 onto the circumferential surface of the gravure plate cylinder 1 including the recesses 2. A sheet-like printing object 5 is printed by the ink on the gravure plate cylinder 1 upon passing between the gravure plate cylinder 1 and the impression cylinder 4.

In this arrangement, when the ink 3 is supplied from the ink supply device 12 onto the circumferential surface of the gravure plate cylinder 1, it fills the recesses 2 in the gravure plate cylinder 1. The ink which fills the recesses 2 is transferred onto the printing object 5 when the recesses 2 are opposed to the impression cylinder 4, thereby printing electrical wiring lines on the printing object 5.

A holding member (not shown) holds first and second doctor blades 6 and 7, the distal ends of which come into contact with the circumferential surface of the gravure plate cylinder 1. The doctor blade 6 is arranged upstream of the doctor blade 7 in the rotation direction of the gravure plate cylinder 1 with a predetermined spacing from it.

The applicant of this invention repeated various kinds of experiments, and the experimental results revealed that as the contact angle between the doctor blade and the circumferential surface of the gravure plate cylinder gets larger, the function of scraping away ink improves but the function of filling the recesses with ink degrades. The experimental results also revealed that as the contact angle between the doctor blade and the circumferential surface of the gravure plate cylinder gets smaller, the function of filling ink in the recesses improves but the function of scraping away ink degrades.

The present invention has been made in consideration of the above-mentioned findings, and proposes that the contact angles between the circumferential surface of the gravure plate cylinder 1 and the first and second doctor blades 6 and 7 should be set to different angles. In the present invention, a contact angle θ1 of the doctor blade 6 with the circumferential surface of the gravure plate cylinder 1 is set less than 45°, and a contact angle θ2 of the doctor blade 7 with the circumferential surface of the gravure plate cylinder 1 is set more than 45°.

Note that the contact angle θ1 means the angle formed between the doctor blade 6 and a segment A1-A2, located upstream in the rotation direction of the gravure plate cylinder 1, on a tangent to the circumferential surface of the gravure plate cylinder 1 at a point A1 where the distal end of the doctor blade 6 comes into contact with this circumferential surface. Also, the contact angle θ2 means the angle formed between the doctor blade 7 and a segment B1-B2, located upstream in the rotation direction of the gravure plate cylinder 1, on a tangent to the circumferential surface of the gravure plate cylinder 1 at a point B1 where the distal end of the doctor blade 7 comes into contact with this circumferential surface.

The relationships between the contact angles of the doctor blades 6 and 7 with the circumferential surface of the gravure plate cylinder 1 and the functions of the doctor blades 6 and 7 will be described next with reference to FIGS. 2A and 2B. As shown in FIG. 2A, when the contact angle θ1 is relatively small, the downward tilt of a vector V representing the force acting on the gravure plate cylinder 1 from a blade surface 6a of the doctor blade 6 is large. In this case, a force V1 with which the doctor blade 6 fills the recesses 2 in the gravure plate cylinder 1 with the ink is large. On the other hand, a force V2 with which the doctor blade 6 scrapes away the ink adhering on the circumferential surface of the gravure plate cylinder 1 is small.

In contrast, as shown in FIG. 2B, when the contact angle θ2 is relatively large, the downward tilt of a vector V representing the force acting on the gravure plate cylinder 1 from a blade surface 7a of the doctor blade 7 is small. In this case, a force V1 with which the doctor blade 7 fills the recesses 2 in the gravure plate cylinder 1 with the ink is small. On the other hand, a force V2 with which the doctor blade 7 scrapes away the ink adhering on the circumferential surface of the gravure plate cylinder 1 is large.

The magnitudes of the force V1 which acts to fill the ink and the force V2 which acts to scrape away the ink, mentioned above, reverse as the contact angle reaches 45°. That is, when the contact angle is less than 45°, the ink filling force produced by the doctor blade is large. However, when the contact angle is more than 45°, the ink scraping force produced by the doctor blade is large.

As described above, the gravure plate cylinder 1 according to the present invention is provided with the first doctor blade 6 having a contact angle θ1 with the gravure plate cylinder 1, that is set less than 45° (0°<θ1<45°), and the second doctor blade 7 having a contact angle θ2 with the gravure plate cylinder 1, that is set more than 45°. The contact angle θ1 need only satisfy 0°<θ1<45°, and the contact angle θ2 need only satisfy 45°<θ2<90°.

In the gravure printing press with the above-mentioned arrangement, the ink 3 supplied from the ink supply device 12 onto the circumferential surface of the gravure plate cylinder 1 is first pushed into the recesses 2 by the doctor blade 6 capable of producing a large filling force, thereby reliably filling the recesses 2 with a necessary amount of ink. Especially when ink containing silver paste is used, the ink itself has high viscosity and a heavy weight, so insufficient filling in the recesses 2 is likely to occur. Therefore, because the doctor blade 6 which exclusively performs an ink filling operation is provided separately from that which performs an ink scraping operation, insufficient filling can be reliably compensated for.

After the doctor blade 6 performs a filling operation, the doctor blade 7 reliably scrapes away superfluous ink adhering on the circumferential surface of the gravure plate cylinder 1. In this case as well, when ink containing silver paste is used, the ink itself has high viscosity and a heavy weight and this makes it hard to scrape away the ink. However, the force V2 with which the doctor blade 7 scrapes away the ink is so large that superfluous ink adhering on the circumferential surface of the gravure plate cylinder 1 can be reliably scraped away. Thus, ink which reliably fills the recesses 2 only by a necessary amount is transferred onto the printing object 5, and superfluous ink adhering on the circumferential surface of the gravure plate cylinder 1 is reliably scraped away. As a result, printing is performed with a sufficient amount of ink and no ink is transferred onto the non-image areas, thus improving the printing quality.

Also, because the doctor blade 6 is provided upstream of the doctor blade 7 in the rotation direction of the gravure plate cylinder 1, the recesses 2 can be reliably filled with the ink 3. After that, the doctor blade 7 can reliably scrape away the ink 3 which does not fill the recesses 2.

### Second Embodiment

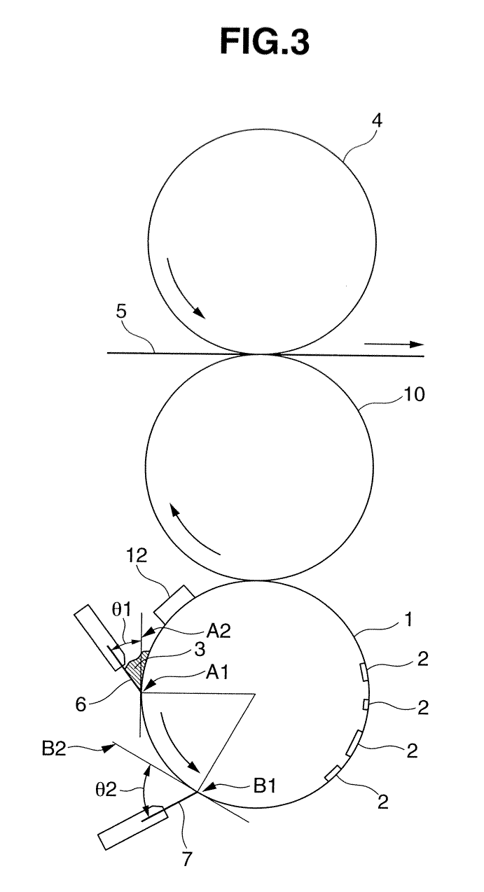

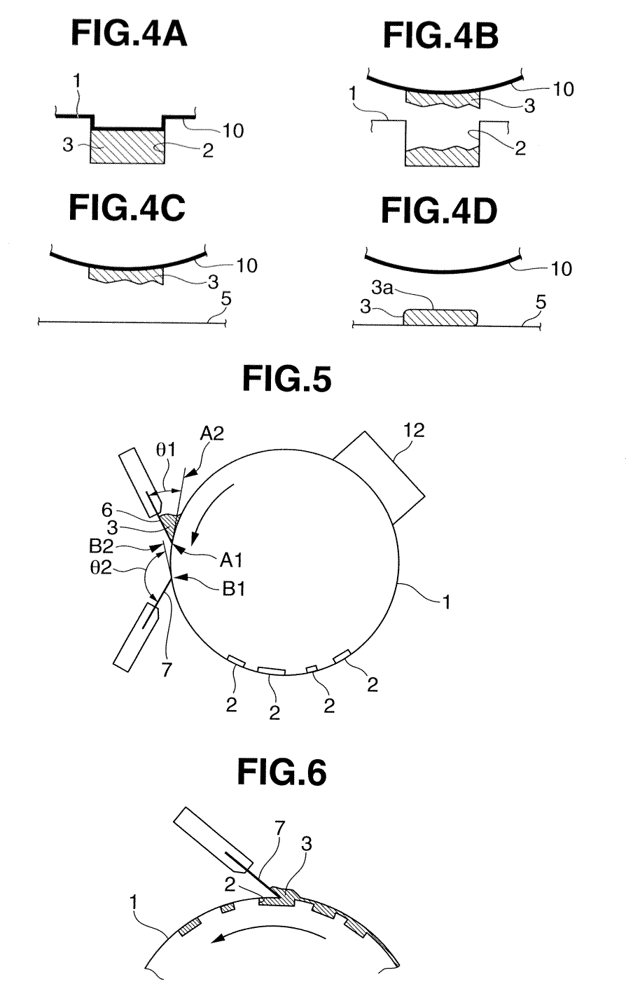

The second embodiment of the present invention will be described next with reference to FIGS. 3 and 4A to 4D. In the second embodiment, a blanket cylinder 10 is opposed to a gravure plate cylinder 1 and an impression cylinder 4 while their circumferential surfaces are kept in contact with each other to perform printing when a printing object 5 passes between the blanket cylinder 10 and the impression cylinder 4. A blanket (not shown) mounted on the circumferential surface of the blanket cylinder 10 is made of a material with a low surface energy, such as silicone. In the second embodiment, contact angles θ1 and θ2 of doctor blades 6 and 7 are set to the same angles as in the first embodiment. That is, the contact angle θ1 of the doctor blade 6 with the circumferential surface of the gravure plate cylinder 1 is set less than 45°, and the contact angle θ2 of the doctor blade 7 with the circumferential surface of the gravure plate cylinder 1 is set more than 45°.

Because the blanket cylinder 10 is more likely to elastically deform, it partly enters recesses 2 in the gravure plate cylinder 1, as shown in FIG. 4A, upon receiving ink 3 from the gravure plate cylinder 1. Thus, the ink in the recesses 2 is pushed by the blanket cylinder 10, thereby bringing the ink 3 into tight contact with the surface of the blanket cylinder 10. As a result, the ink 3 transferred onto the blanket cylinder 10 is reliably transferred onto the surface of the blanket cylinder 10 to reproduce the image on the plate, as shown in FIG. 4B.

The ink 3 transferred onto the blanket cylinder 10 is opposed to the printing object 5 with rotation of the blanket cylinder 10, as shown in FIG. 4C. The ink 3 is pressed against the printing object 5 by the action of the impression cylinder 4, thereby transferring it onto the printing object 5, as shown in FIG. 4D. At this time, because the blanket cylinder 10 deforms and has a low surface energy, the separation characteristics of the ink are so good that the ink 3 does not stay behind on the surface of the blanket cylinder 10. In this manner, almost the entire amount of ink 3 on the blanket cylinder 10 is reliably transferred onto the printing object 5, so a printing surface 3a of the ink 3 becomes smooth. As a result, the entire surface of the printing object 5, including the portions to be printed by the ink 3, becomes smooth, thus improving the printing quality.

### Third Embodiment

The third embodiment of the present invention will be described next with reference to FIGS. 5 and 6. The feature of the third embodiment lies in that a reverse-angle doctor blade is used as a doctor blade 7, that is, a contact angle θ2 of the doctor blade 7 is set more than 90°, as shown in FIG. 5. Note that a contact angle θ1 of a doctor blade 6 is set less than 45°, as in the first and second embodiments.

The reverse-angle doctor blade can be more efficiently, effectively prevented from falling into recesses 2 while strengthening the ink scraping force, as compared with a doctor blade with a contact angle θ2 of 45° to 90°. Accordingly, because the reverse-angle doctor blade enters the recesses 2 only by a small amount upon bending, and the ink which has already filled the recesses 2 is not scraped away, as shown in FIG. 6. Therefore, ink 3 which fills the recesses 2 is stored intact, and superfluous ink adhering on the circumferential surface of a gravure plate cylinder 1 is reliably scraped away. As a result, no ink is transferred onto the non-image areas, thus improving the printing quality.

Although an example in which each of the doctor blade 6 having a contact angle of less than 45° and the doctor blade 7 having a contact angle of more than 45° is provided in one portion has been described in each of the above-mentioned embodiments, one or both of the doctor blades 6 and 7 may be provided in two or more portions as needed. In this case, three or more doctor blades 6 and 7 are freely arranged as needed with respect to the rotation direction of the gravure plate cylinder 1.

Also, although the doctor blade 6 is arranged upstream of the doctor blade 7 in the rotation direction of the gravure plate cylinder 1, the doctor blade 7 may be arranged upstream of the doctor blade 6 in the rotation direction of the gravure plate cylinder 1.

Moreover, although silver paste has been taken as an example of the component contained in the ink 3, the present invention is not limited to this. For example, the component contained in the ink 3 may be carbon which has so small a particle diameter that it is hard for the doctor blade to scrape away it, and need only be a paste with high viscosity. Although the blanket mounted on the blanket cylinder 10 is made of silicone, the present invention is not limited to this. For example, this blanket may be made of PTFE (polytetrafluoroethylene) or PVDF (polyvinylidene fluoride), and need only be a material with a low surface energy and good separation characteristics.

As has been described above, according to the present invention, because the first blade can reliably fill the recesses in the gravure plate cylinder with the ink, a necessary amount of ink is transferred onto the printing object. Also, the second blade reliably scrapes away the ink in the non-image areas, thus improving the printing quality.

What is claimed is:

1. A gravure printing press comprising:
a gravure plate cylinder which includes, on a circumferential surface thereof, a plurality of recesses that form image areas upon being filled with ink;
an ink supply device which supplies the ink onto the circumferential surface of said gravure plate cylinder;
a first blade which comes into contact with the circumferential surface of said gravure plate cylinder at a contact angle of less than 45°; and
a second blade which comes into contact with the circumferential surface of said gravure plate cylinder at a contact angle of more than 45°.

2. An apparatus according to claim 1, wherein
said first blade is arranged upstream of said second blade in a rotation direction of said gravure plate cylinder.

3. An apparatus according to claim 1, wherein
the contact angle of said second blade with the circumferential surface of said gravure plate cylinder is set more than 90°.

4. An apparatus according to claim 1, further comprising:
an impression cylinder which is opposed to said gravure plate cylinder while circumferential surfaces thereof are kept in contact with each other,
wherein printing is performed when a printing object passes between said gravure plate cylinder and said impression cylinder.

5. An apparatus according to claim 1, further comprising:
a blanket cylinder which is opposed to said gravure plate cylinder while circumferential surfaces thereof are kept in contact with each other; and
an impression cylinder which is opposed to said blanket cylinder,
wherein printing is performed when a printing object passes between said blanket cylinder and said impression cylinder.

6. An apparatus according to claim 1, wherein
said first blade fills said plurality of recesses with the ink, and said second blade scrapes away the ink which does not fill said plurality of recesses.

7. An apparatus according to claim 1, wherein
the ink supplied from said ink supply device contains a paste with high viscosity.

8. An apparatus according to claim 7, wherein
the paste which is contained in the ink and has high viscosity includes silver paste.
